(19) United States
(12) Patent Application Publication
(10) Pub. No.: US 2023/0278166 A1
(43) Pub. Date: Sep. 7, 2023

(54) POWER TOOL

(71) Applicant: MAKITA CORPORATION, Anjo-shi (JP)

(72) Inventors: Pengfei YANG, Kunshan (CN); Mingli LEI, Kunshan (CN); Hideharu MUTO, Anjo-shi (JP)

(73) Assignee: MAKITA CORPORATION, Anjo-shi (JP)

(21) Appl. No.: 18/093,523

(22) Filed: Jan. 5, 2023

(30) Foreign Application Priority Data
Mar. 4, 2022 (JP) 2022-033511

(51) Int. Cl. B24B 55/10; B24B 23/02; B26B 25/00; B25F 5/00

(52) U.S. Cl. CPC B24B 55/102; B24B 23/02; B26B 25/002; B25F 5/008

(57) ABSTRACT

A dust cover has improved operability for attachment and detachment. A power tool to which a disk tool is attachable includes an electric motor including a motor shaft, a housing accommodating the electric motor and having an inlet to draw outside air, a dust cover being a plate including a filter covering the inlet and being attachable to and detachable from the housing, a grip extending from the housing in a direction perpendicular to the motor shaft and located between the disk tool and the inlet in a direction in which the motor shaft extends, and a spindle coaxial with the motor shaft, protruding from an end of the housing to receive the disk tool, and rotatable by the electric motor.

### CROSS-REFERENCE TO RELATED APPLICATIONS

This application claims the benefit of priority to Japanese Patent Application No. 2022-033511, filed on Mar. 4, 2022, the entire contents of which are hereby incorporated by reference.

### BACKGROUND

### 1. Technical Field

The present disclosure relates to a power tool used for, for example, cutting or grinding stone or steel pipes.

### 2. Description of the Background

A known power tool includes an electric motor accommodated in a tool body to serve as a driving source for rotating a tip tool such as a grinding disk or a diamond wheel. Cooling air is drawn into the tool body to cool the electric motor. A dust cover is attached to an inlet in the power tool to prevent dust. The dust cover is removable for cleaning.

Various structures have been developed for attaching a dust cover. U.S. Pat. No. 8,398,465 (hereafter, Patent Literature 1) describes a semicylindrical dust cover formed from rubber. The dust cover has two ends engaged with a tool body. The dust cover is thus attached to an inlet in the power tool under an elastic force. U.S. Patent Application Publication No. 2020/0276694 (hereafter, Patent Literature 2) describes a dust cover including engagement tabs that are slid on a tool body for engagement. The dust cover is thus attached to an inlet in a power tool. The engagement tabs each include a hook to prevent the tabs from slipping off. Japanese Patent No. 5961711 (hereafter, Patent Literature 3) describes a dust cover including a triangular frame formed from rubber. The dust cover is attached to an inlet with pin-like protrusions on the corners of the triangular frame. The protrusions are placed in the corresponding attachment holes in a tool body.

### BRIEF SUMMARY

The dust cover described in Patent Literature 1 has its two ends to be held to deform against an elastic force, lowering the operability for attachment and detachment. The dust cover described in Patent Literature 2 has its engagement tabs with hooks to be disengaged, involving time-consuming detachment. The dust cover described in Patent Literature 3 has its frame formed from rubber and easily deformable, involving time-consuming detachment.

One or more aspects of the present disclosure are directed to a dust cover with improved operability for attachment and detachment.

A first aspect of the present disclosure provides a power tool to which a disk tool is attachable, the power tool including:
an electric motor including a motor shaft;
a housing accommodating the electric motor, the housing having an inlet to draw outside air;
a dust cover being a plate including a filter covering the inlet, the dust cover being attachable to and detachable from the housing;
a grip extending from the housing in a direction perpendicular to the motor shaft, the grip being located between the disk tool and the inlet in a direction in which the motor shaft extends; and
a spindle coaxial with the motor shaft, the spindle protruding from an end of the housing to receive the disk tool, the spindle being rotatable by the electric motor.

The dust cover according to the above aspect of the present disclosure is easily operable for attachment and detachment.

### BRIEF DESCRIPTION OF DRAWINGS

FIG. 1 is a top view of a power tool according to an embodiment.

FIG. 2 is a left side view of the power tool as viewed in the direction indicated by arrow II in FIG. 1, showing the internal structure being uncovered without a left housing half.

FIG. 3 is a right side view of the power tool as viewed in the direction indicated by arrow III in FIG. 1.

FIG. 4 is a bottom view of the power tool taken along line IV-IV in FIG. 3 as viewed in the direction indicated by arrows, showing the internal structure of a tool body being uncovered.

FIG. 5 is a perspective view of the power tool with a dust cover attached as viewed obliquely from the right rear.

FIG. 6 is a perspective view of the power tool with the dust cover removed as viewed obliquely from right above.

FIG. 7 is a perspective view of the dust cover as viewed in the direction indicated by arrow VII in FIG. 6.

FIG. 8 is a sectional view taken along line VIII-VIII in FIG. 7, as viewed in the direction indicated by arrows.

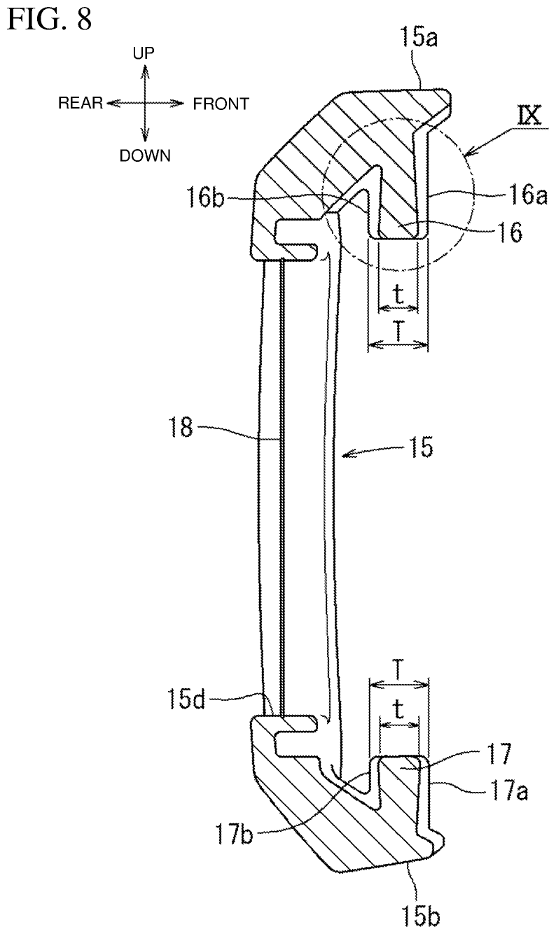

FIG. 9 is an enlarged view of part IX in FIG. 8.

FIG. 10 is a sectional view taken along line X-X in FIG. 7, as viewed in the direction indicated by arrows.

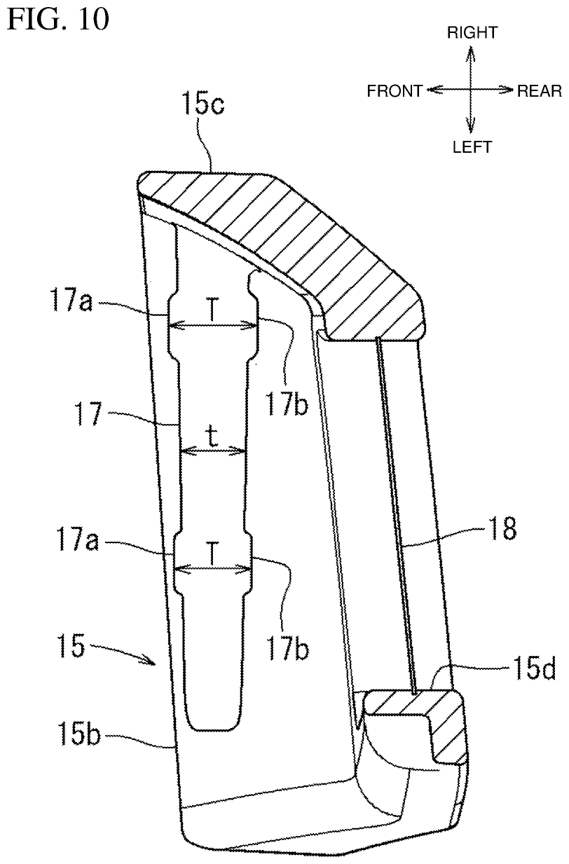

FIG. 11 is a sectional view of the dust cover being attached, taken along line XI-XI in FIG. 1 as viewed in the direction indicated by arrows.

FIG. 12 is an enlarged view of part XII in FIG. 11.

FIG. 13 is a sectional view of the dust cover being attached, taken along line XIII-XIII in FIG. 1 as viewed in the direction indicated by arrows.

FIG. 14 is an enlarged view of part XIV in FIG. 13.

### DETAILED DESCRIPTION

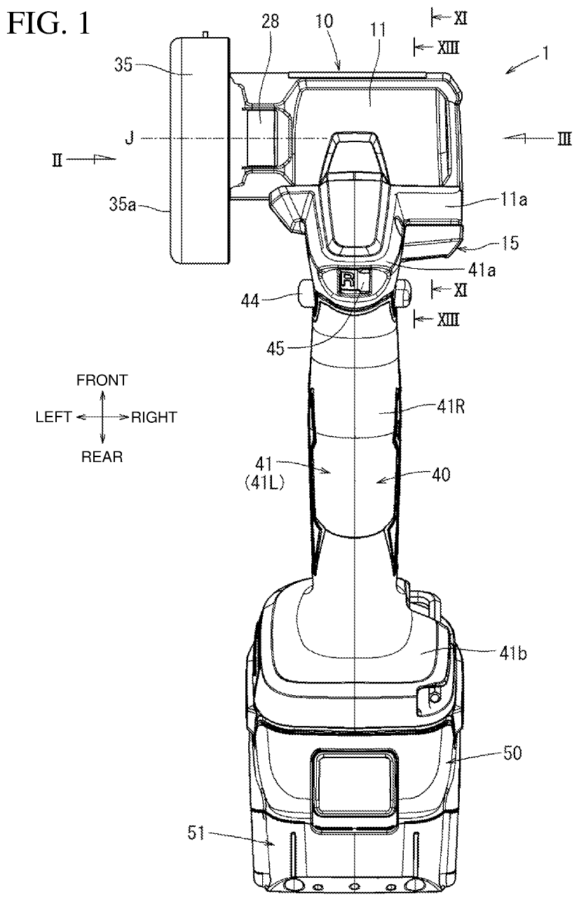

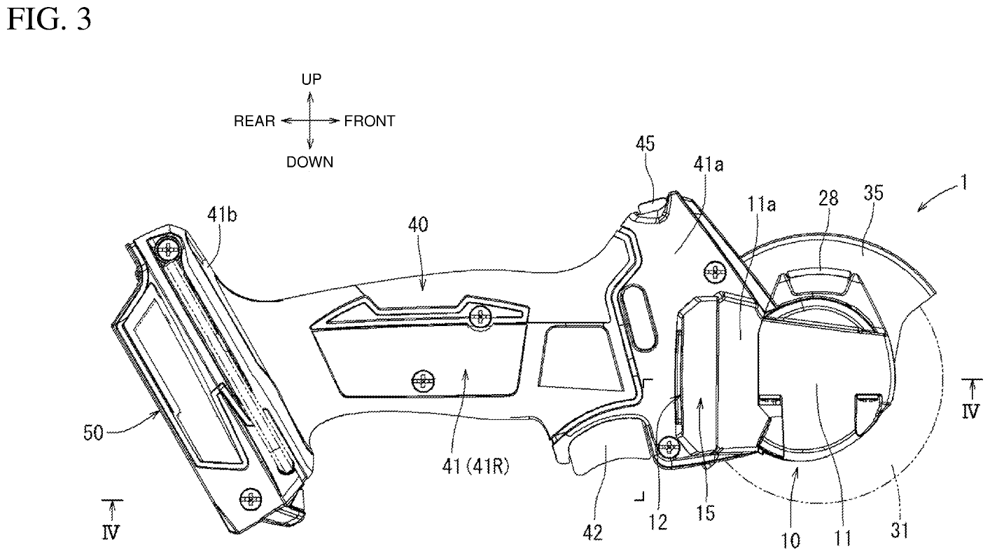

FIGS. 1 to 4 show a power tool 1 according to an embodiment. The power tool 1 according to the present embodiment is a portable machining apparatus also referred to as a compact cutoff tool.

The portable machining apparatus is a portable tool used by an operator supporting the entire weight of the tool by hand. The portable machining apparatus performs machining including cutting, corner chamfering, or grooving. The compact cutoff tool includes a disk tool such as a grinding disk or a diamond wheel with a diameter of about 70 to 80 mm (typically 3 inches or 75 mm in the market). The compact cutoff tool can be used to cut metal or concrete by switching the rotation direction of the disk tool as appropriate for its application.

Switching the rotation direction may cause accidental entry of dust, which is resulting from cutting, into the apparatus. The portable machining apparatus is thus to have improved dust protection, in particular, improved filter replacement performance.

In the present embodiment, the longitudinal direction of the power tool 1 is defined as the front-rear direction, and the position at which a user gripping the power tool 1 stays is defined as the rear. The lateral direction is defined as viewed from the user.

The power tool 1 includes a tool body 10 and a grip 40. The tool body 10 includes a cylindrical main housing 11 and an electric motor 20 (drive source). The main housing 11 accommodates the electric motor 20. The grip 40 is grippable by the user. The main housing 11 includes upper and lower halves.

The electric motor 20 is a direct current (DC) brushless motor including a stator 21 and a rotor 22 adjacent to the inner circumference of the stator 21. The stator 21 is fixed along the inner peripheral surface of the main housing 11. An annular sensor board 27 is connected to the right end of the stator 21. The sensor board 27 detects, for example, rotational position information about the rotor 22.

The rotor 22 is connected to a motor shaft 23. The motor shaft 23 is supported by the main housing 11 with left and right bearings 24 and 25 in a rotatable manner. The rotor 22 is supported about the axis of the motor shaft 23 (motor axis J) in a rotatable manner. The right end of the motor shaft 23 protrudes rightward through the inner circumference of the sensor board 27. The protruding right end of the motor shaft 23 is supported on the right side of the main housing 11 with the right bearing 25.

A cooling fan 26 is located on the left of the rotor 22. The cooling fan 26 is connected to the motor shaft 23. In response to activation of the electric motor 20, the cooling fan 26 rotates together with the motor shaft 23. This draws outside air into the main housing 11 to cool the electric motor 20. The flow of cooling air will be described later.

A spindle 30 is coaxially connected to the left end of motor shaft 23. The spindle 30 is supported by the main housing 11 with the left bearing 24 in a rotatable manner. The spindle 30 rotates together with the motor shaft 23 about the motor axis J.

The spindle 30 includes a left portion protruding from the left side of the main housing 11. A disk tool 31 is attached to the left end of the spindle 30. The disk tool 31 in the present embodiment is a grinding disk with a relatively small diameter. The disk tool 31 is attached to the spindle 30 between an outer flange 32 and an inner flange 33 along the motor axis J. A fixing screw 34 at the left end face of the spindle 30 is tightened to generate a clamping force between the outer flange 32 and the inner flange 33. The disk tool 31 rotates in the same direction and at the same speed as the electric motor 20.

The disk tool 31 is covered with a tool cover 35. The tool cover 35 is semicircular and covers substantially half the circumference of the disk tool 31. The tool cover 35 may be at any position within a predetermined range about the motor axis J. The tool cover 35 mainly prevents scattering of dust, such as cutting dust, toward the user.

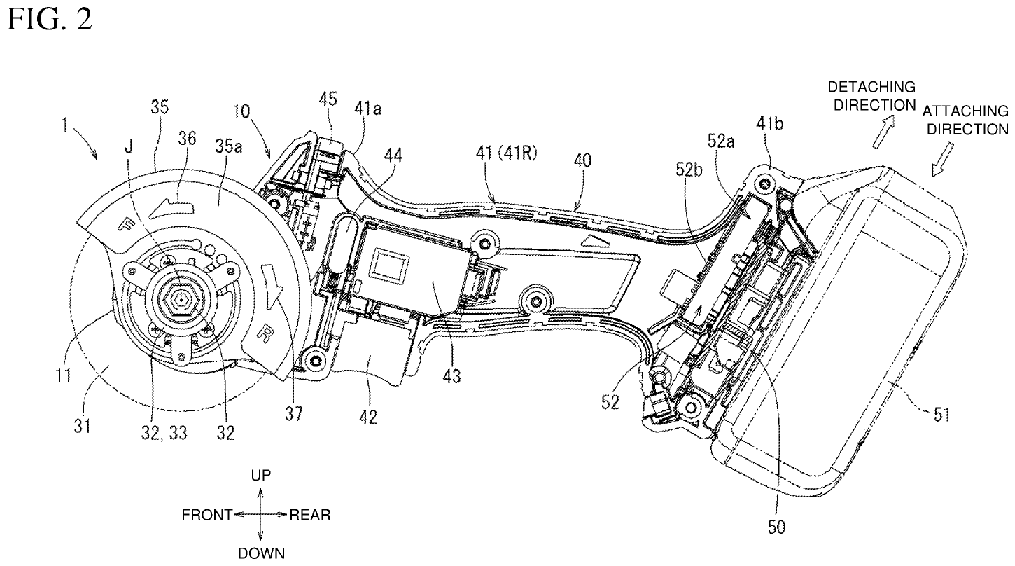

The rotation direction (forward or reverse) of the electric motor 20 is switchable with a forward-reverse switch 45 (described later). This switches the rotation direction of the disk tool 31. As shown in FIG. 2, the tool cover 35 has a left side surface 35a showing arrows indicating the rotation direction of the disk tool 31. Arrow 36 with a letter F (forward) indicates the forward direction (counterclockwise in FIG. 2). Arrow 37 with a letter R (reverse) indicates the reverse direction (clockwise in FIG. 2).

The rotation direction of the disk tool 31 is changed to change the direction in which dust scatters. When the rotation direction of the disk tool 31 is switched in accordance with, for example, the working posture, the position of the tool cover 35 about the motor axis J is adjusted. This effectively reduces dust scattering toward the user.

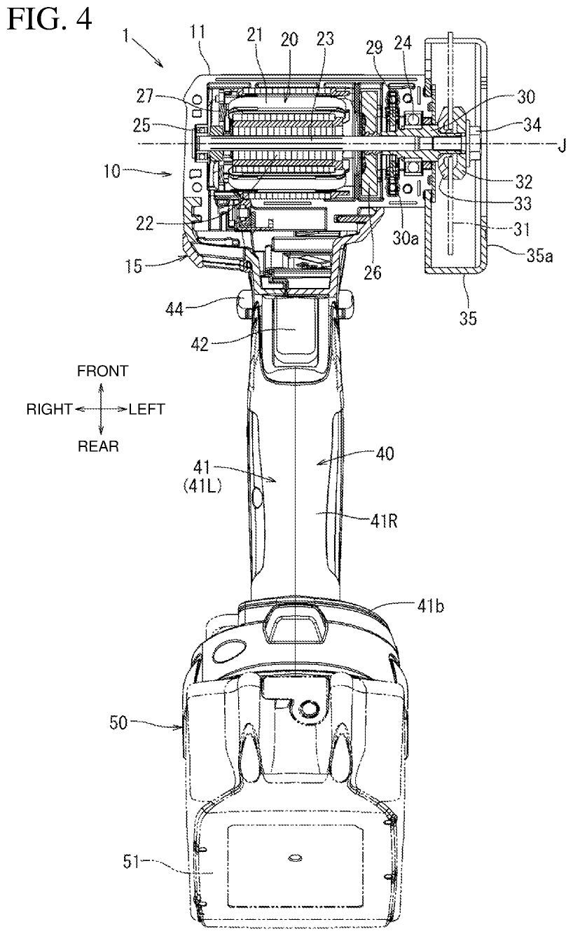

As shown in FIG. 1, a spindle lock button 28 is located on an upper left surface of the tool body 10. In response to the spindle lock button 28 being depressed, a locking plate 29 shown in FIG. 4 moves to engage with flat portions 30a with a width across flats on the spindle 30. This locks the spindle 30 not to rotate, allowing for replacement of the disk tool 31. In response to the depressing being released, the spindle lock button 28 and the locking plate 29 are separate from the flat portions 30a with a width across flats under a spring force and return to their unlocked positions.

The grip 40 extends rearward from the main housing 11. The grip housing 41 defines an outer wall of the grip 40. The grip housing 41 includes a left housing half 41L and a right housing half 41R joined to each other. The grip housing 41 is connected to the rear surface of the main housing 11. FIG. 2 shows the power tool without the left housing half 41L.

An activation switch 42 is located on a lower front surface of the grip 40. The activation switch 42 is a trigger switch lever that is pulled with a fingertip of the hand holding the grip 40. A switch body 43 is accommodated above the activation switch 42. In response to the activation switch 42 being pulled, the switch body 43 is turned on to activate the electric motor 20.

An unlock button 44 is located in front of the switch body 43. The unlock button 44 is a rod switch lever. The unlock button 44 is supported in a front portion of the grip housing 41 in a manner movable in the lateral direction. When a protruding end (e.g., a left end) of the unlock button 44 is pressed toward the other end (e.g., a right end or an unlocking end) with a fingertip, the activation switch 42 is released from being locked. The grip 40 accommodates a compression spring (not shown) urging the unlock button 44 to the left and to the right. When the finger is removed from the protruding end being pressed, the unlock button 44 automatically returns to its original position under an urging force from the compression spring. The locking unit operates in the same manner when the protruding right end of the unlock button 44 is pressed. The activation switch 42 is pulled with the unlock button 44 being unlocked to start the electric motor 20.

The unlock button 44 may protrude either to the left or to the right alone (mostly to the left). The structure is the same as the unlock button 44 having protruding two ends, except that one end protrudes alone.

In response to the pulling of the activation switch 42 being released, the unlock button 44 returns to its original position, thus locking the activation switch 42 not to be pulled. This avoids accidental activation of the activation switch 42.

The grip housing 41 includes a raised portion 41a raised upward on its upper front surface. The raised portion 41a serves as a stopper for regulating displacement of the hand holding the grip 40 forward. The forward-reverse switch 45 is located on the upper surface of the raised portion 41a. The forward-reverse switch 45 is a tumbler switch operable with a lever tilting to the left or to the right.

In response to an operation on the forward-reverse switch 45 with a fingertip, the rotation direction of the electric motor 20 is switched. For example, in response to the forward-reverse switch 45 being tilted to the left, the disk tool 31 rotates forward. In response to the forward-reverse switch 45 being tilted to the right, the disk tool 31 rotates reversely.

The grip housing 41 includes a rear portion integral with a mount base 41b. The mount base 41b extends in front-rear and lateral directions. The mount base 41b receives a battery mount 50. A single battery pack 51 is attached to the battery mount 50 in a slidable manner. As shown in FIG. 2, the battery pack 51 is slid downward relative to the battery mount 50 for attachment. The battery pack 51 is slid upward relative to the battery mount 50 for detachment.

A single controller 52 that is a plate is located at the front of the battery mount 50. The controller 52 includes a case 52a and a control board 52b. The case 52a is shallow and rectangular. The control board 52b is accommodated in the case 52a and insulated by resin molding. The control board 52b is accommodated inside the mount base 41b along the length of the mount base 41b. The controller 52 is accommodated with the control board 52b (adjacent to the opening of the case 52a) facing frontward.

The control board 52b includes a control circuit including a microcomputer that transmits control signals based on positional information about the rotor 22 detected by the sensor board 27 included in the electric motor 20. The control board 52b further includes a drive circuit including a field-effect transistor (FET) that switches a current flowing through the electric motor 20 in response to a control signal received from the control circuit. The control board 52b further includes an automatic stop circuit that cuts power supply to the electric motor 20 to prevent overdischarge or overcurrent in accordance with the detected status of the battery pack 51.

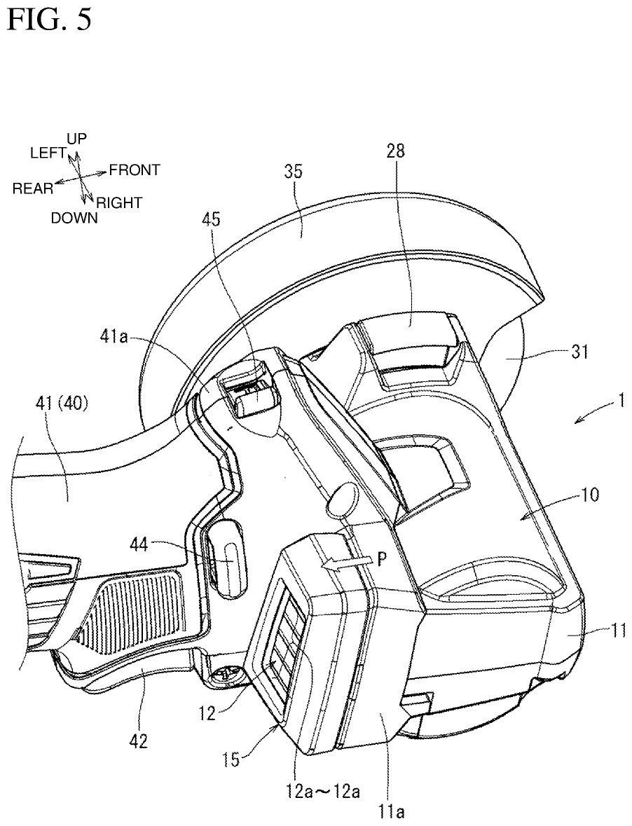

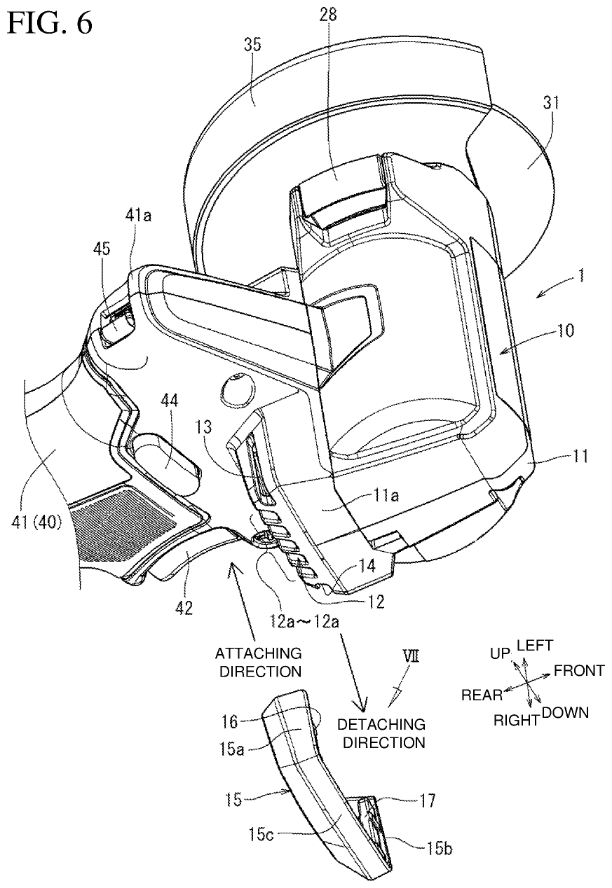

In response to the electric motor 20 being activated, the cooling fan 26 rotates and draws outside air into the main housing 11. As shown in FIGS. 1, 3, 5, and 6, a plate-like base 11a is located on the right rear surface of the main housing 11. The base 11a is on the right of the raised portion 41a of the grip housing 41. The base 11a has an inlet 12 for drawing outside air. As shown in FIGS. 5 and 6, the inlet 12 includes multiple slits partitioned by multiple ribs 12a. Each slit extends laterally.

Outside air drawn in through the inlet 12 in the right rear surface of the main housing 11 flows leftward through the main housing 11. This cools mainly the stator 21, the rotor 22, and the sensor board 27. The air flown leftward through the main housing 11 to cool the motor is then discharged outside through, for example, an outlet in the main housing 11 below the cooling fan 26.

A single dust cover 15 is detachably attached to the inlet 12. The dust cover 15 reduces dust or other matter flowing into the inlet 12. The dust cover 15 is detached and cleaned for maintenance.

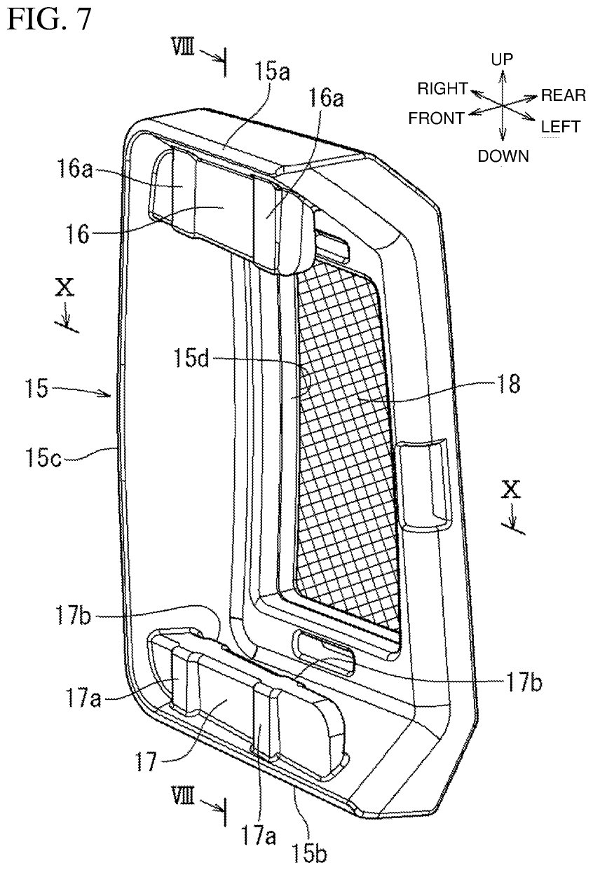

As shown in FIG. 7, the dust cover 15 is a substantially flat frame. The dust cover 15 has a side wall 15a on the upper edge, a side wall 15b on the lower edge, and a side wall 15c on the right edge. Each of the side walls 15a, 15b, and 15c protrudes frontward with the same height. The three side walls 15a, 15b, and 15c produce high rigidity in the plate-like dust cover 15 in a planar direction. A pair of rails 16 and 17 are integral with the pair of side walls 15a and 15b that vertically face each other. The pair of rails 16 and 17 protrude toward each other to form ridges.

The pair of rails 16 and 17 are elongated laterally. The pair of rails 16 and 17 serve as slide supports for attachment by sliding. The upper rail 16 is integral with two deformable protrusions 16a and two deformable protrusions 16b. The lower rail 17 is integral with two deformable protrusions 17a and two deformable protrusions 17b.

The two deformable protrusions 16a are located on the front surface of the upper rail 16 at a laterally predetermined distance. Although not shown in FIG. 7, the two deformable protrusions 16b are located on the rear surface of the upper rail 16 at the same distance as on the front surface. The deformable protrusions 16a on the front surface and the deformable protrusions 16b on the rear surface align with each other while facing in the directions opposite to each other in the front-rear direction.

The two deformable protrusions 17a are located on the front surface of the lower rail 17 at a laterally predetermined distance. The two deformable protrusions 17b are located on the rear surface of the lower rail 17 at the same distance as on the front surface. The deformable protrusions 17a on the front surface and the deformable protrusions 17b on the rear surface align with each other while facing in the directions opposite to each other in the front-rear direction.

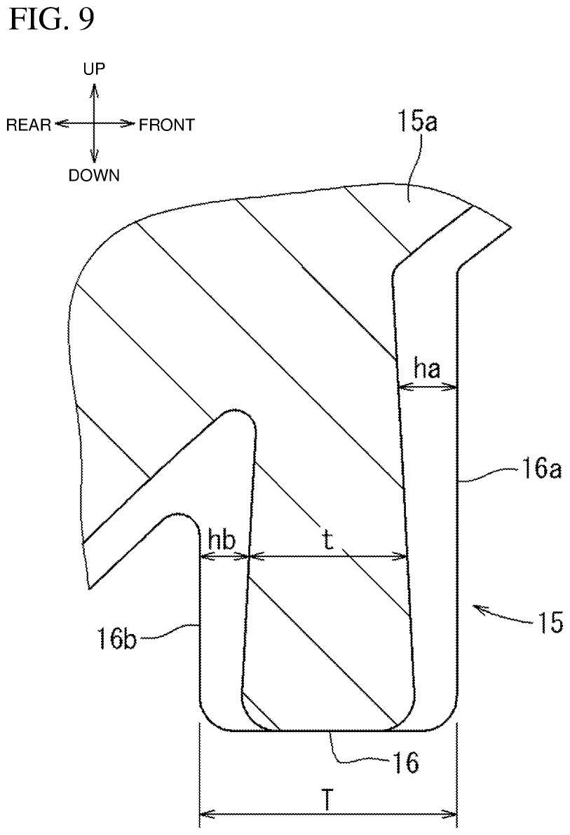

As shown in FIG. 9, the upper rail 16 includes an undercut, or specifically, the upper rail 16 has a thickness t gradually increasing toward its protruding distal end (lower end). The front surfaces of the deformable protrusions 16a on the front surface and the rear surfaces of the deformable protrusions 16b on the rear surface are substantially parallel to one another. The front deformable protrusions 16a each have a height ha from the front surface of the rail 16. The rear deformable protrusions 16b each have a height hb from the rear surface of the rail 16. The heights ha and hb gradually increase toward the basal end of the protruding rail 16 (upper end).

Similarly to the upper rail 16, the lower rail 17 also includes an undercut. The front deformable protrusions 17a and the rear deformable protrusions 17b have heights gradually increasing toward the basal end of the protruding rail 17. Similarly to the upper deformable protrusions 16a and 16b, the front surfaces of the deformable protrusions 17a on the front surface and the rear surfaces of the deformable protrusions 17b on the rear surface are substantially parallel to one another.

The dust cover 15 has an opening 15d in the bottom (rear) surface. A wire mesh filter 18 covers the opening 15d. Outside air is drawn into the inlet 12 through the filter 18. This prevents dust from entering the inlet 12.

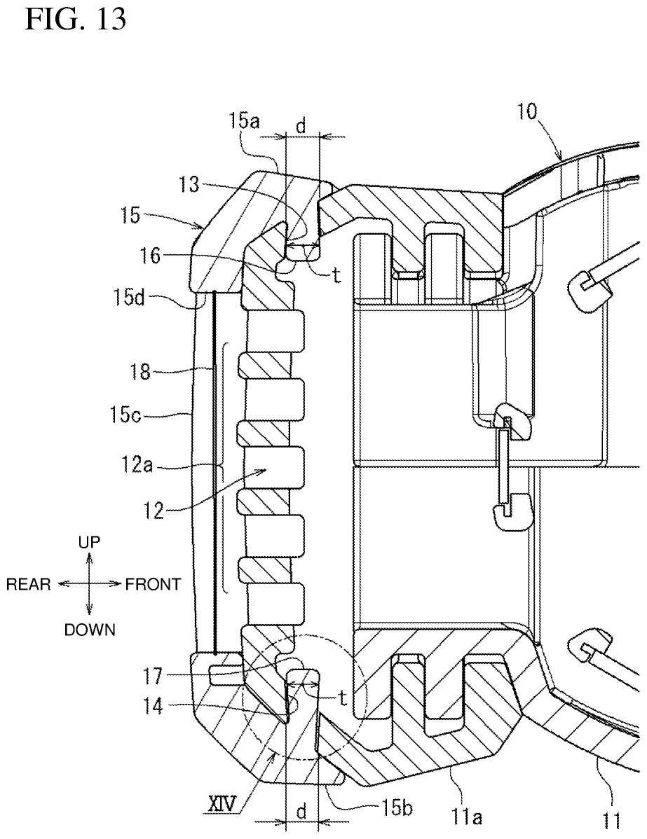

As shown in FIGS. 6, 11, and 13, the base 11a includes a pair of upper and lower rail receivers 13 and 14 on the upper and lower surfaces. The rail receivers 13 and 14 include elongated recesses (grooves) extending leftward from the right side surface of the base 11a. The rail receivers 13 and 14 are parallel to each other.

The rail receivers 13 and 14 extend through the upper and lower side surfaces of the base 11a in the thickness direction of the side surfaces. The thickness direction of the upper and lower side surfaces corresponds to the depth direction of the rail receivers 13 and 14. A more inward portion of the base 11a is deeper in the depth direction. Amore outward portion of the base 11a is shallower in the depth direction. The rail receivers 13 and 14 receive the rails 16 and 17 on the dust cover 15.

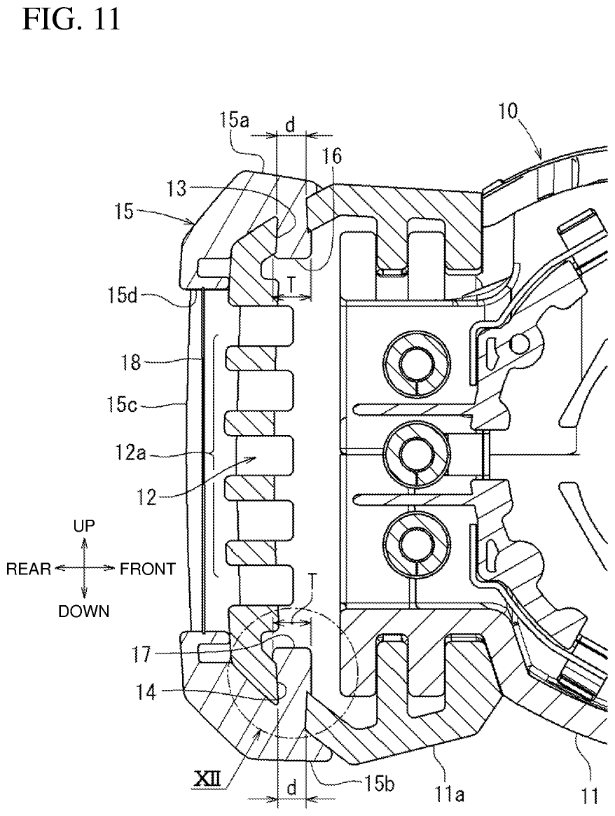

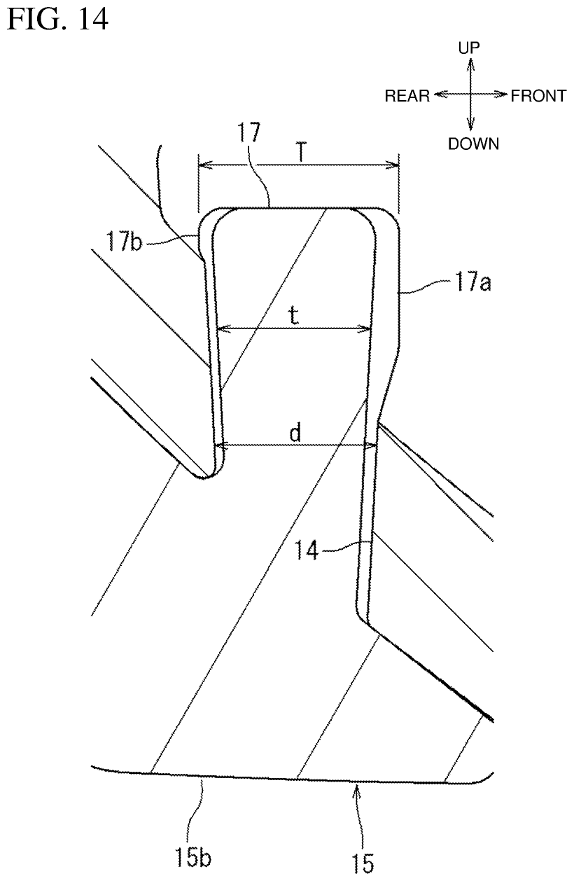

As shown in FIGS. 11 to 14, the upper and lower rail receivers 13 and 14 each have a groove width d increasing at a more inward position of the base 11a (deeper in the rail receivers 13 and 14). The rails 16 and 17 on the dust cover 15 each have a thickness t increasing from the basal end toward the distal end (deeper in the rail receivers 13 and 14). The upper and lower rail receivers 13 and 14 thus have the undercuts in conformance with the rails 16 and 17 on the dust cover 15.

The groove width d of the upper or lower rail receiver 13 or 14 is greater than the thickness t of the upper or lower rail 16 or 17. The rail receivers 13 and 14 each have the groove width d less than a thickness T between the deformable protrusions 16a and 16b and than a thickness T between the deformable protrusions 17a and 17b. The deformable protrusions 16a, 16b, 17a, and 17b formed discontinuously in the longitudinal direction of the rails 16 and 17 produce appropriate sliding resistance to the rail receivers 13 and 14.

As shown in FIG. 6, with the right side wall 15c on the right, the upper and lower rails 16 and 17 are placed in and along the upper and lower rail receivers 13 and 14, and the dust cover 15 is slid leftward relative to the base 11a. The dust cover 15 is then attached to cover the inlet 12.

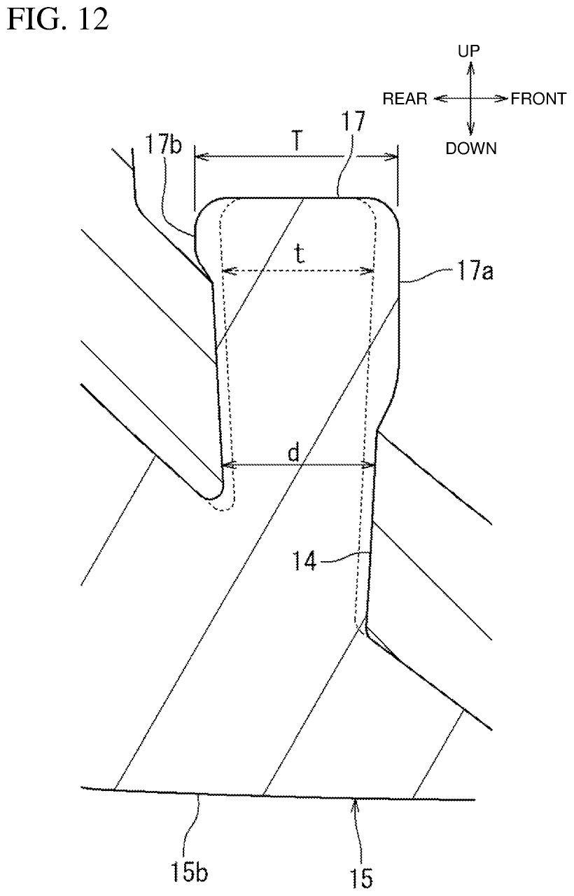

As shown in FIGS. 11 and 12, when the rails 16 and 17 move along the upper and lower rail receivers 13 and 14, the deformable protrusions 16a, 16b, 17a, and 17b are elastically deformed and compressed. The compressed deformable protrusions 16a, 16b, 17a, and 17b produce sliding resistance and retain the dust cover 15 being attached. This prevents the dust cover 15 from accidentally slipping off the base 11a.

FIGS. 5, 11, and 13 show the dust cover 15 being attached. With the dust cover 15 being attached to the base 11a, the inlet 12 includes its rear portion covered with the filter 18. This prevents dust from entering the main housing 11 through the inlet 12.

With the dust cover 15 being attached, the upper rail 16 is placed along the upper rail receiver 13, and the lower rail 17 is placed along the lower rail receiver 14. The rails 16 and 17 with the undercuts are placed along the rail receivers 13 and 14 with the undercuts. This regulates the displacement of the rails 16 and 17 in the slipping direction relative to the rail receivers 13 and 14 in the depth direction (a direction intersecting with the sliding direction). This retains the dust cover 15 being attached more firmly. For example, when the upper side wall 15a of the dust cover 15 receives an external force applied backward indicated by outlined arrow P in FIG. 5 and the upper rail 16 separates from the rail receiver 13, the rail 17 is prevented from separating from the lower rail receiver 14. This prevents the dust cover 15 from slipping off the base 11a.

As shown in FIG. 6, the dust cover 15 is slid rightward with the upper and lower side walls 15a and 15b held with fingertips. This allows smooth removal of the dust cover 15. The deformable protrusions 16a, 16b, 17a, and 17b are formed locally rather than along the full length of the rails 16 and 17. The dust cover 15 is thus slidable in the removal direction with appropriate sliding resistance.

The plate-like dust cover 15 in the present embodiment is slidable in the lateral direction (planar direction) to be attached to or detached from the base 11a in the main housing 11. This structure allows the dust cover 15 to be removed effortlessly, unlike a known dust cover with tabs to be removed or a known dust cover to be elastically deformed entirely for detachment.

With the dust cover 15 in the present embodiment being attached, the deformable protrusions 16a, 16b, 17a, and 17b on the rails 16 and 17 are elastically deformed and compressed. This produces appropriate resistance against movement for attachment and detachment of the dust cover 15 to and from the base 11a in the main housing 11 in the sliding direction. This avoids accidental slipping off of the dust cover 15 and facilitates easy detachment of the dust cover 15. The deformable protrusions 16a, 16b, 17a, and 17b may be set to an appropriate height to control the resistance against movement of the dust cover 15. The deformable protrusions 16a, 16b, 17a, and 17b may be formed at more or fewer positions (or more or fewer deformable protrusions are used) to control the resistance against movement. For example, one deformable protrusion or three or more deformable protrusions may be formed on one or both surfaces of each of the rails 16 and 17.

The rails 16 and 17 and the rail receivers 13 and 14 in the present embodiment each have the undercut. In other words, the rails 16 and 17 have the thickness t increasing toward the bottoms of the rail receivers 13 and 14. The rail receivers 13 and 14 each have the groove width d increasing toward the bottom. This prevents the rails 16 and 17 from slipping off in a direction perpendicular to the sliding direction of the rails 16 and 17 relative to the rail receivers 13 and 14, preventing the dust cover 15 from slipping off unintentionally or accidentally. Either the rail receivers or the rails alone may have the undercuts.

The power tool 1 according to the present embodiment is a hand-held portable machining apparatus including the forward-reverse switch 45 that switches the rotation direction of the electric motor 20. This allows the blowing direction of dust to be changed by switching the rotation direction of the disk tool 31. The work environment is thus maintained appropriately.

The grip 40 in the present embodiment is located between the disk tool 31 and the inlet 12 in a direction in which the motor shaft 23 extends. The inlet 12 is thus located apart from the dust generating area, preventing dust from entering the inlet 12 and the dust cover 15 more effectively. The dust cover 15 is slid in a direction (rightward) away from the disk tool 31 for detachment. This prevents dust from entering the inlet 12 and the dust cover 15 more effectively.

The power tool 1 according to the present embodiment includes, at the rear of the grip 40, the battery mount 50 to which the battery pack 51 for supplying power to the electric motor 20 is attachable. The power tool 1 without a cable has improved workability and is easier to handle than a power tool powered by alternate current (AC), to which a power cable is to be connected. The battery pack 51 is attached to an end of the grip 40 (handle) opposite to a processing end to reliably maintain workability.

The present embodiment may be modified in various manners. For example, rails being recesses may be located on the dust cover 15, and rail receivers being ridges may be located on the base 11a.

The deformable protrusions may be located on the rail receivers instead of being located on the rails as illustrated above, or may be located on both.

Either the undercuts in the rails 16 and 17 (change in the thickness t) or the undercuts in the rail receivers 13 and 14 (change in the groove width d) may be used alone, or both the undercuts may be eliminated.

Although the dust cover 15 is slidable in the lateral direction for attachment and detachment, the dust cover 15 may be slidable vertically relative to the base 11a for attachment and detachment. The dust cover 15 may be attached differently, or to the right front surface, the right upper surface, the right lower surface, or the right surface of the tool body 10, instead of being attached to the right rear surface as described above.

The disk tool 31 may be, for example, a diamond wheel, instead of a grinding disk. Although the power tool 1 is a cutting tool for cutting a workpiece by rotating the disk tool 31 in an example, the above dust cover is applicable to a drilling tool or a screwing tool that rotates a bit. The above dust cover slidably attachable or detachable is also applicable to a hand-held rotary tool that includes an electric motor accommodated in a grip to rotate a spindle about an axis perpendicular to a motor axis J.

### REFERENCE SIGNS LIST

1 power tool (compact cutoff tool)
10 tool body
11 main housing
11a base
12 inlet
12a rib
13 (upper) rail receiver
14 (lower) rail receiver
d groove width of rail receiver 13 or 14
15 dust cover
15a (upper) side wall
15b (lower) side wall
15c (right) side wall
15d opening
16 (upper) rail
16a (front) deformable protrusion
16b (rear) deformable protrusion
17 (lower) rail
17a (front) deformable protrusion
17b (rear) deformable protrusion
t thickness of rail 16 or 17
18 filter
P external force applied to dust cover 15
20 electric motor
21 stator
22 rotor
23 motor shaft
J motor axis
24, 25 bearing
26 cooling fan
27 sensor board
28 spindle lock button
29 locking plate
30 spindle
30a flat portion with width across flats
31 disk tool
32 outer flange
33 inner flange
34 fixing screw
35 tool cover
35a left side surface
36 arrow (forward direction)
37 arrow (reverse direction)
40 grip
41 grip housing
41L (left) housing half
41R (right) housing half
41a raised portion
41b mount base
42 activation switch
43 switch body
44 unlock button
45 forward-reverse switch
battery mount
51 battery pack
52 controller
52a case
52b control board

What is claimed is:

1. A power tool to which a disk tool is attachable, the power tool comprising:
an electric motor including a motor shaft;
a housing accommodating the electric motor, the housing having an inlet to draw outside air;
a dust cover being a plate including a filter covering the inlet, the dust cover being attachable to and detachable from the housing;
a grip extending from the housing in a direction perpendicular to the motor shaft, the grip being located between the disk tool and the inlet in a direction in which the motor shaft extends; and
a spindle coaxial with the motor shaft, the spindle protruding from an end of the housing to receive the disk tool, the spindle being rotatable by the electric motor.

2. The power tool according to claim 1, wherein
the dust cover includes a first rail and a second rail along two edges of the inlet, and
the dust cover is slidable in a planar direction of the dust cover along the first rail and the second rail to be attached to or detached from the housing.

3. The power tool according to claim 2, wherein
the dust cover includes a first side wall and a second side wall facing each other along the two edges of the inlet, and
the first rail protrudes from the first side wall toward the second side wall, and the second rail protrudes from the second side wall toward the first side wall.

4. The power tool according to claim 2, wherein
the housing includes a first rail receiver and a second rail receiver being recesses to receive the first rail and the second rail in a slidable manner,
each of the first rail and the second rail includes a deformable protrusion protruding in a thickness direction, and
the deformable protrusion has a height to deform elastically in response to the first rail being received in the first rail receiver and the second rail being received in the second rail receiver.

5. The power tool according to claim 4, wherein
each of the first rail and the second rail has two surfaces each including the deformable protrusion.

6. The power tool according to claim 2, wherein
the housing includes a first rail receiver and a second rail receiver holding the first rail and the second rail in a slidable manner,
the first rail and the second rail are ridges and the first rail receiver and the second rail receiver are recesses to hold the ridges in a slidable manner, or the first rail receiver and the second rail receiver are ridges and the first rail and the second rail are recesses to hold the ridges in a slidable manner,
each of the ridges has a thickness increasing at a deeper position of a corresponding recess of the recesses, and
each of the recesses has a width increasing at the deeper position.

7. The power tool according to claim 1, wherein
the power tool is a portable machining apparatus, and
the portable machining apparatus further comprises a forward-reverse switch configured to switch a rotation direction of the electric motor.

8. The power tool according to claim 2, wherein
the first rail and the second rail extend to allow the dust cover to slide in a direction away from the disk tool for detachment.

9. The power tool according to claim 1, further comprising:
a battery mount to which a battery pack for supplying power to the electric motor is attachable, the battery mount being at an end of the grip.

10. The power tool according to claim 3, wherein
the housing includes a first rail receiver and a second rail receiver being recesses to receive the first rail and the second rail in a slidable manner,
each of the first rail and the second rail includes a deformable protrusion protruding in a thickness direction, and
the deformable protrusion has a height to deform elastically in response to the first rail being received in the first rail receiver and the second rail being received in the second rail receiver.

11. The power tool according to claim 3, wherein
the housing includes a first rail receiver and a second rail receiver holding the first rail and the second rail in a slidable manner,
the first rail and the second rail are ridges and the first rail receiver and the second rail receiver are recesses to hold the ridges in a slidable manner, or the first rail receiver and the second rail receiver are ridges and the first rail and the second rail are recesses to hold the ridges in a slidable manner,
each of the ridges has a thickness increasing at a deeper position of a corresponding recess of the recesses, and
each of the recesses has a width increasing at the deeper position.

12. The power tool according to claim 2, wherein
the power tool is a portable machining apparatus, and
the portable machining apparatus further comprises a forward-reverse switch configured to switch a rotation direction of the electric motor.

13. The power tool according to claim 3, wherein
the power tool is a portable machining apparatus, and
the portable machining apparatus further comprises a forward-reverse switch configured to switch a rotation direction of the electric motor.

14. The power tool according to claim 4, wherein
the power tool is a portable machining apparatus, and
the portable machining apparatus further comprises a forward-reverse switch configured to switch a rotation direction of the electric motor.

15. The power tool according to claim 5, wherein
the power tool is a portable machining apparatus, and
the portable machining apparatus further comprises a forward-reverse switch configured to switch a rotation direction of the electric motor.

16. The power tool according to claim 6, wherein
the power tool is a portable machining apparatus, and
the portable machining apparatus further comprises a forward-reverse switch configured to switch a rotation direction of the electric motor.

17. The power tool according to claim 3, wherein
the first rail and the second rail extend to allow the dust cover to slide in a direction away from the disk tool for detachment.

18. The power tool according to claim 4, wherein
the first rail and the second rail extend to allow the dust cover to slide in a direction away from the disk tool for detachment.

19. The power tool according to claim 5, wherein
the first rail and the second rail extend to allow the dust cover to slide in a direction away from the disk tool for detachment.

20. The power tool according to claim 6, wherein
the first rail and the second rail extend to allow the dust cover to slide in a direction away from the disk tool for detachment.
